(19) United States
(12) Patent Application Publication
(10) Pub. No.: US 2007/0253792 A1
(43) Pub. Date: Nov. 1, 2007

(54) TORQUE LIMITING BREAK-AWAY HEAD FASTENER AND RELATED METHODS

(75) Inventors: James L. Zahnen, Ormond Beach, FL (US); Paul W. Lubinsky, Palm Coast, FL (US); Marie T. Lubinsky, Palm Coast, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Homac Mfg. Company, Ormond Beach, FL (US)

(21) Appl. No.: 11/380,514

(22) Filed: Apr. 27, 2006

(51) Int. Cl. F16B 31/00

(52) U.S. Cl. 411/5

(57) ABSTRACT

A torque-limited fastener is for an electrical connector including an electrically conductive body having at least one fastener-receiving passageway intersecting a cable-receiving passageway. The torque-limited fastener may include a body being externally threaded to be received within the fastener-receiving passageway and having a tool-receiving passageway therein. A break-away head may be initially coupled to the body for breaking away therefrom at a torque limit upon tightening of the fastener. The break-away head may have a tool-receiving passageway therethrough aligned with the tool-receiving passageway of the body and accommodating a commonly-sized tool therein. At least one tool stop may extend inwardly in the tool-receiving passageway of the break-away head to restrict insertion of the commonly-sized tool for tightening to a torque limit, and being removed upon breaking away of the break-away head thereby permitting insertion of the commonly-sized tool into the tool-receiving passageway of the body to facilitate removal thereof.

### FIELD OF THE INVENTION

The present invention relates to the field of fasteners, and, more particularly, to screw-type fasteners such as for securing an electrical cable within a passageway of an electrically conductive connector body, for example.

### BACKGROUND OF THE INVENTION

Electrical cables are commonly secured within passageways of electrically conductive connector bodies using a variety of fasteners. Such a fastener may include an externally threaded shaft received by an internally threaded passageway of the connector body. The fastener may further include a break-away head with an exterior hexagonal pattern to be tightened by a suitable tool and for separating from the externally threaded shaft upon tightening to a torque limit. This permits the fastener to be installed to a desired torque without requiring special tools, such as a torque indicating wrench, and without requiring special care by the installer in using the torque indicating wrench.

It may be desirable to remove a fastener with a break-away head after it is installed. Accordingly, several approaches have been proposed for backing out the fastener from the connector body upon the break-away head separating from the fastener. Such fastener structures may include a larger exterior hexagonal pattern further down the shaft from the break-away head to be engaged by a larger socket for removing the fastener, for example. Unfortunately, such a configuration may make the fastener undesirably long for certain applications since the second larger exterior hexagonal pattern restricts how far the fastener may be received into its corresponding passageway.

A fastener including a break-away head is disclosed in U.S. Pat. No. 6,176,659 to Hardt et al. The break-away head has a predetermined breaking point along the fastener, below which are a plurality of predetermined breaking points between the fastener's adjacent threaded portions. The torque limit is applied by the outer hexagon face of the break-away head for an upper portion of the corresponding breaking points, and an inner passageway extending through the screw for a lower portion corresponding to the other breaking points.

A fastener having two internal stepped-diameter tool-receiving passageways is disclosed in U.S. Pat. No. 3,963,322 to Gryctko. A first and second tool-receiving passageway respectively extend through the break-away head and tip portions, the second tool-receiving passageway having a smaller width than the first tool-receiving passageway. The break-away head may be separated from the fastener and removed from its fastener-receiving passageway by inserting a first tightening tool into the first tool-receiving passageway and tightening the break-away head to a torque limit. To remove the tip from the passageway, the second tightening tool is inserted in the second tool-receiving passageway. A similar fastener is disclosed in U.S. Pat. No. 6,004,349 to Jackson, that includes upper and lower tool-receiving passageways formed in the respective break-away head and lower portion of a fastener. Upon breaking away of the break-away head from the lower portion, the lower tool-receiving passageway receives an easy out tool into a reverse thread to remove the lower portion of the fastener.

A fastener including a plurality of stepped-down diameter tool-receiving passageways is disclosed in U.S. Pat. No. 6,056,753 also to Jackson. The fastener includes a cylindrical stepped down bore including a first tool-receiving passageway, a second tool-receiving passageway, a third tool-receiving passageway and a fourth tool-receiving passageway, of decreasing diameter. Each adjacent tool-receiving passageway is separated by a corresponding internal shoulder extending radially inwardly into the bore. The first stepped-down diameter occurs at the first turn in the external thread below the break-away head.

The stepped-down diameter tool receiving passageways discussed above provide approaches for removing the lower fastener portion upon breaking away of the break-away head. However, these fasteners require a variety of fastening tools with dimensions corresponding to the respective stepped diameter passageways. Further, forming such internal stepped-diameter passageways may involve more detailed manufacturing processes.

### SUMMARY OF THE INVENTION

In view of the foregoing background, it is therefore an object of the present invention to provide a torque-limited fastener that may be more readily installed and later removed.

This and other objects, features, and advantages in accordance with the present invention are provided by a torque-limited fastener, such as for an electrical connector, and including a body and a break-away head having respective aligned tool-receiving passageways for receiving a commonly-sized tool. More particularly, the fastener may comprise a body being externally threaded to be received within a fastener-receiving passageway of an electrical connector, and having its tool-receiving passageway therein. The break-away head may be initially coupled to the body for breaking away therefrom at a torque limit upon tightening of the fastener. The break-away head may have its tool-receiving passageway extend therethrough and be aligned with the tool-receiving passageway of the body and accommodating a commonly-sized tool therein. At least one tool stop may extend inwardly in the tool-receiving passageway of the break-away head to restrict insertion of the commonly-sized tool for tightening to a torque limit, and the at least one tool stop may be removed upon breaking away of the break-away head. This permits insertion of the commonly-sized tool into the tool-receiving passageway of the body to facilitate removal thereof.

The break-away head may comprise metal, for example. According to one advantageous feature of the fastener, the at least one tool stop may comprise metal portions displaced from adjacent metal portions of the break-away head. Manufacturing of the fastener is thereby facilitated. In some embodiments, the at least one tool stop may comprise a plurality of radially inwardly extending tool stops.

The tool-receiving passageway of the body may extend only partway therein. The body may have a cable-contacting end opposite the break-away head. In addition, the break-away head may include a reduced diameter portion adjacent the body.

the tool-receiving passageway of the break-away head may have a hexagonal cross-sectional shape. The tool-receiving passageway of the body may also have a hexagonal cross-sectional shape to thereby receive the commonly-sized tool, such as an Allen wrench. The break-away head may also have a hexagonal cross-sectional outer shape.

A method aspect is for making the torque-limited fastener. The method may include forming a body with external threads and a tool-receiving passageway therein. The method may further include forming a break-away head initially coupled to the body for breaking away from the body at a torque limit upon tightening of the fastener, with the break-away head having a tool-receiving passageway aligned with the tool-receiving passageway of the body and accommodating a commonly-sized tool. The method may further include forming at least one tool stop extending inwardly in the tool-receiving passageway of the break-away head.

### BRIEF DESCRIPTION OF THE DRAWINGS

FIG. 1 is a side elevational exploded view of an electrical connector and a torque-limited fastener according to the present invention.

FIG. 2 is a fragmentary view of a portion of the electrical connector shown in FIG. 1.

FIG. 3 is a perspective cross-sectional view of the torque-limited fastener shown in FIG. 1.

FIG. 4 is a cross-sectional view of the fastener as shown in FIG. 1 having a commonly-sized tool inserted within the tool-receiving passageway of the break-away head.

FIG. 5 is a cross-sectional view of the fastener as shown in FIG. 1 having the commonly-sized tool inserted within the tool-receiving passageway of the body after the break-away head has been removed.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

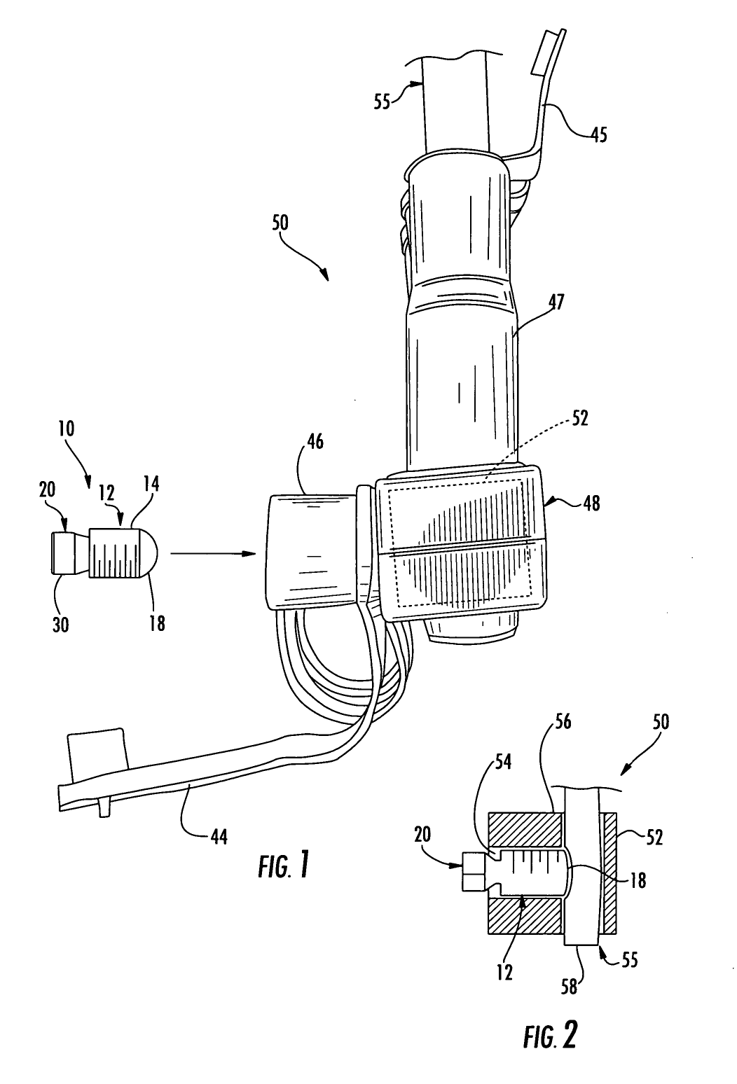

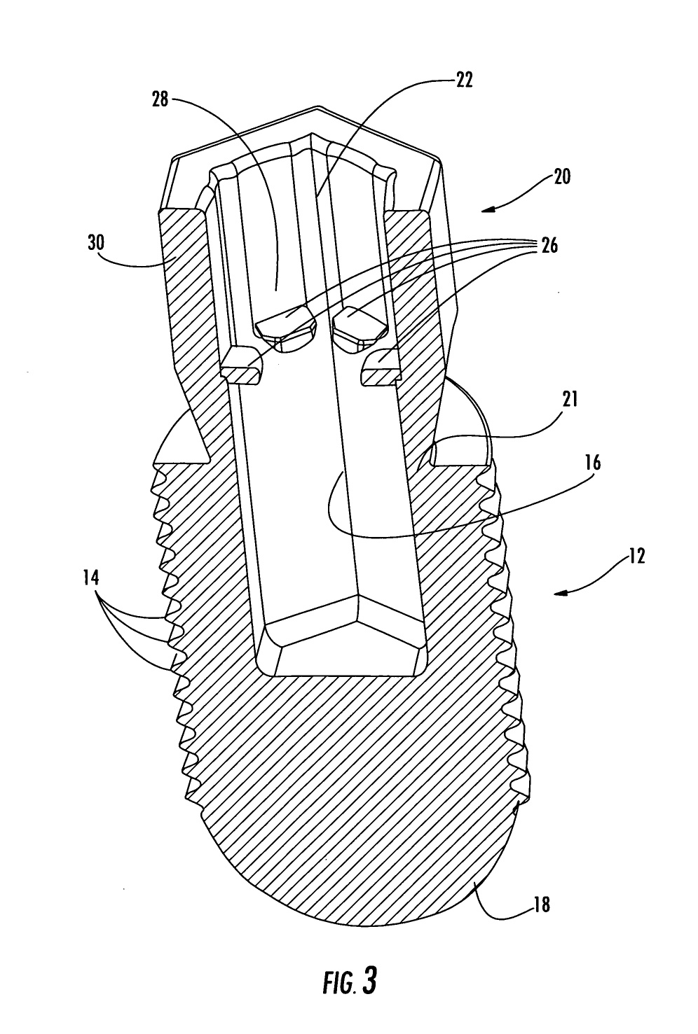

Referring initially to FIGS. 1-3, a torque-limited fastener 10 for securing within a fastener-receiving passageway 54 of an electrical connector 50 is now described. The electrical connector 50 includes an electrically conductive body 52 having a fastener-receiving passageway 54 intersecting a cable-receiving passageway 56. Such an electrical connector is disclosed in U.S. Pat. No. 6,997,759, assigned to the assignee of the present invention, and the entire subject matter of which is incorporated herein by reference. Fasteners, such as the torque-limited fastener 10, may be secured within the fastener-receiving passageway 54 so as to secure the electrical conductor 58 of an electrical cable 55 within the cable-receiving passageway 56.

The electrical connector also illustratively includes an insulating cover 48, such as formed of a thermoplastic elastomer (TPE) or other materials as will be appreciated by those skilled in the art. The insulating cover 48 also includes integrally molded tubular cable-receiving ports 47 and tubular fastener-receiving ports 46. Respective tether assemblies 44, 45 are used to close corresponding openings as described in U.S. Pat. No. 6,997,759. Of course, as will also be appreciated by those skilled in the art, the electrical connector 50 may take other forms.

The torque-limited fastener 10 illustratively includes a body 12 with external threads 14 for engaging mating internal threads of the fastener-receiving passageway 54. The external threads 14 cover a portion of the body 12 length sufficient to secure the torque-limited fastener 10 within the fastener-receiving passageway 54.

The torque-limited fastener 10 further includes a break-away head 20 initially coupled to the body 12 for breaking away from the body at a torque limit upon tightening of the fastener. The specific torque limit depends on the material and dimensions of the break-away head 20, particularly at its coupling area to the body 12, as appreciated by one of skill in the art. The coupling area of the break-away head 20 may be in the form of the illustrated reduced diameter portion 21 the adjacent body 12. Other configurations are also contemplated.

The torque-limited fastener 10 including the break-away head 20 and body 12 may comprise metal, such as aluminum, for example. The body 12 illustratively includes a rounded cable-contacting end 18 opposite the break-away head 20 for contacting the conductor 58 of the cable 55 within the cable-receiving passageway 56 upon securing the fastener 10 within the fastener-receiving passageway 54.

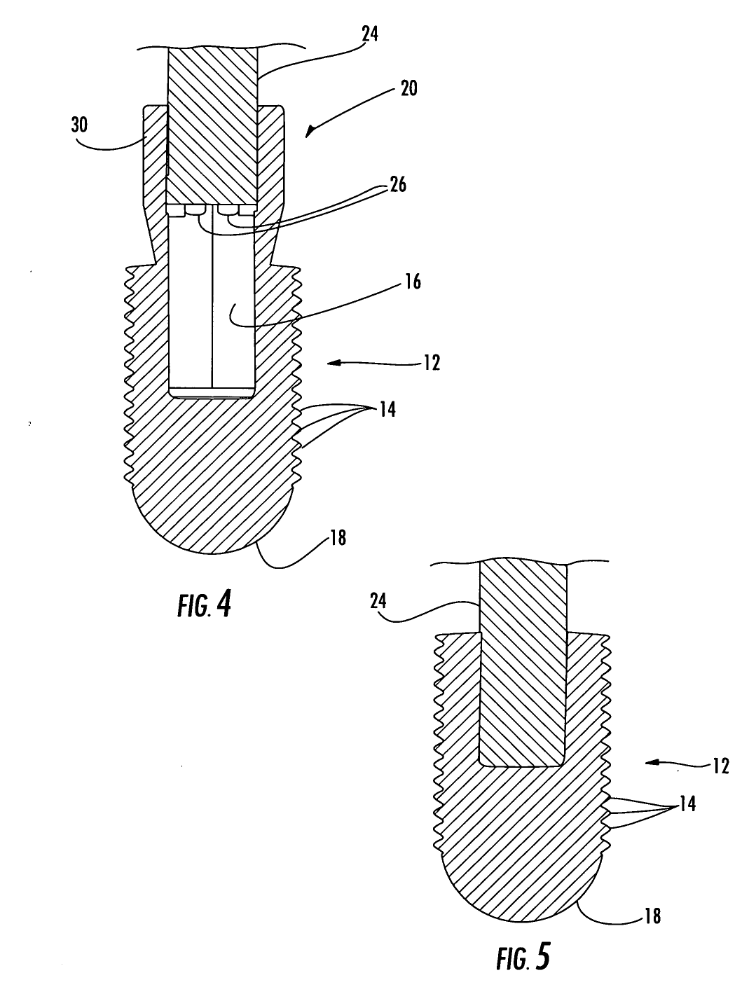

Referring now additionally to FIGS. 4-5, the tool-receiving passageway 16 of the body 12 may extend only partway into the body. The break-away head 20 has a tool-receiving passageway 22 aligned with the tool-receiving passageway 16 of the body 12 and accommodates a commonly-sized tool 24. The tool receiving passageways 16, 22 may have respective hexagonal cross-sections as shown in the illustrated embodiment although other shapes are possible as will be appreciated by those skilled in the art. Upon inserting the commonly-sized tool 24 in either of the tool receiving passageways 16, 22, the commonly-sized tool 24, such as an Allen wrench having a hexagonal cross-sectional outer shape, engages the respective surfaces of the tool-receiving passageways.

Upon insertion of the commonly-sized tool 24 into the tool-receiving passageway 22 of the break-away head 20, a plurality of tool stops 26 extending radially inwardly into the tool-receiving passageway 22 restrict insertion of the commonly-sized tool beyond the tool stops 26 (FIG.4). Upon engaging the tool stops 26, the commonly-sized tool 24 may tighten the break-away head 20 to the torque limit, causing removal of the tool stops with the breaking away of the break-away head. Removal of the tool stops 26 from the tool-receiving passageway 22 upon breaking away of the break-away head 20 permits insertion of the commonly-sized tool 24 into the tool-receiving passageway 16 of the body 12 to facilitate removal of the body from the fastener-receiving passageway (FIG.5). Although a plurality of tool stops 26 are illustratively extending radially inwardly in the tool-receiving passageway 22, in other embodiments only a single tool stop can be used.

The break-away head 20 may have a hexagonal cross-sectional outer shape as shown in the illustrated embodiment. Accordingly, an appropriately configured wrench or socket tool may be optionally used to tighten the break-away head 20 to the torque limit, and break away the break-away head from the body 12, as may also be done using the commonly-sized tool 24 within the tool-receiving passageway 22.

The break-away head 20 may include metal, and the tool stops 26 may include metal portions displaced from adjacent portions 28 of the break-away head 20 as understood perhaps best with reference to FIG. 3. Such metal portions may be displaced by a suitable punching or coining operation as will be appreciated by those of skill in the art.

A method aspect of the present invention is for making the torque-limited fastener 10. The method may include forming a body 12 with external threads 14 and a tool-receiving passageway 16. The method may further include forming a break-away head 20 initially coupled to the body 12 for breaking away from the body at a torque limit upon tightening of the fastener 10, with the break-away head having a tool-receiving passageway 22 aligned with the tool-receiving passageway 16 of the body and accommodating a commonly-sized tool 24. The method may further include forming a plurality of tool stops 26 extending inwardly in the tool-receiving passageway 22 of the break-away head 20.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A torque-limited fastener for an electrical connector comprising an electrically conductive body having at least one fastener-receiving passageway intersecting a cable-receiving passageway, the torque-limited fastener comprising:
a body being externally threaded to be received within the at least one fastener-receiving passageway;
said body having a tool-receiving passageway therein;
a break-away head initially coupled to said body for breaking away therefrom at a torque limit upon tightening of the fastener;
said break-away head having a tool-receiving passageway therethrough aligned with the tool-receiving passageway of said body and accommodating a commonly-sized tool therein; and
at least one tool stop extending inwardly in the tool-receiving passageway of said break-away head to restrict insertion of the commonly-sized tool for tightening to the torque limit, and being removed upon breaking away of said break-away head thereby permitting insertion of the commonly-sized tool into the tool-receiving passageway of said body to facilitate removal thereof.

2. The torque-limited fastener according to claim 1, wherein said break-away head comprises metal; and wherein said at least one tool stop comprises metal portions displaced from adjacent metal portions of said break-away head.

3. The torque-limited fastener according to claim 1, wherein said at least one tool stop comprises a plurality of radially inwardly extending tool stops.

4. The torque-limited fastener according to claim 1, wherein the tool-receiving passageway of said body extends only partway therein.

5. The torque-limited fastener according to claim 1, wherein said break-away head comprises a reduced diameter portion adjacent said body.

6. The torque-limited fastener according to claim 1, wherein the tool-receiving passageway of said break-away head has a hexagonal cross-sectional shape; and wherein the tool-receiving passageway of said body has a hexagonal cross-sectional shape.

7. The torque-limited fastener according to claim 1, wherein said break-away head has a hexagonal cross-sectional outer shape.

8. The torque-limited fastener according to claim 1, wherein said body has a cable-contacting end opposite said break-away head.

9. An electrical connector comprising:
an electrically conductive body having at least one cable-receiving passageway therein, and at least one fastener-receiving passageway intersecting the at least one cable-receiving passageway; and
a torque-limited fastener within said at least one fastener-receiving passageway and comprising
a body being externally threaded,
said body having a tool-receiving passageway therein,
a break-away head initially coupled to said body for breaking away therefrom at a torque limit upon tightening of the fastener,
said break-away head having a tool-receiving passageway therethrough aligned with the tool-receiving passageway of said body and accommodating a commonly-sized tool therein, and
at least one tool stop extending inwardly in the tool-receiving passageway of said break-away head.

10. The electrical connector according to claim 9, wherein said break-away head of said torque-limited fastener comprises metal; and wherein said at least one tool stop comprises metal portions displaced from adjacent metal portions of said break-away.

11. The electrical connector according to claim 9, wherein said at least one tool stop of said torque-limited fastener comprises a plurality of radially inwardly extending tool stops.

12. The electrical connector according to claim 9, wherein the tool-receiving passageway of said body of said torque-limited fastener extends only partway therein.

13. The electrical connector according to claim 9, wherein said break-away head of said torque-limited fastener comprises a reduced diameter portion adjacent said body.

14. The electrical connector according to claim 9, wherein the tool-receiving passageway of said break-away bead of said torque-limited fastener has a hexagonal cross-sectional shape; and wherein the tool-receiving passageway of said body of said torque-limited fastener has a hexagonal cross-sectional shape.

15. The electrical connector according to claim 9, wherein said break-away head of said torque-limited fastener has an hexagonal cross-sectional outer shape.

16. The electrical connector according to claim 9, wherein said body of said torque-limited fastener has a cable-contacting end opposite said break-away head.

17. The electrical connector according to claim 9, further comprising an insulating cover on said electrically conductive body.

18. A torque-limited fastener comprising:
a body being externally threaded;
said body having a tool-receiving passageway therein;
a break-away head initially coupled to said body for breaking away therefrom at a torque limit upon tightening of the fastener;
said break-away head having a tool-receiving passageway therethrough aligned with the tool-receiving passageway of said body and accommodating a commonly-sized tool therein; and
a plurality of tool stop extending radially inwardly in the tool-receiving passageway of said break-away head.

19. The torque-limited fastener according to claim 18, wherein said break-away head comprises metal; and wherein said plurality of tool stops comprise metal portions displaced from adjacent portions of said break-away head.

20. The torque-limited fastener according to claim 18, wherein the tool-receiving passageway of said body extends only partway therein.

21. The torque-limited fastener according to claim 18, wherein said break-away head comprises a reduced diameter portion adjacent said body.

22. The torque-limited fastener according to claim 18, wherein the tool-receiving passageway of said break-away head has a hexagonal cross-sectional shape, and wherein the tool-receiving passageway of said break-away head has a hexagonal cross-sectional shape.

23. The torque-limited fastener according to claim 18, wherein the tool-receiving passageway of said body has a hexagonal cross-sectional shape.

24. The torque-limited fastener according to claim 18, wherein said body has a cable-contacting end opposite said break-away head.

25. A method for making a torque-limited fastener comprising:
forming a body being externally threaded and having a tool-receiving passageway therein;
forming a break-away head initially coupled to the body for breaking away therefrom at a torque limit upon tightening of the fastener, with the break-away head having a tool-receiving passageway therethrough aligned with the tool-receiving passageway of the body and accommodating a commonly-sized tool therein; and
forming at least one tool stop extending inwardly in the tool-receiving passageway of the break-away head.

26. The method according to claim 25, wherein the break-away head comprises metal; and wherein forming the at least one tool stop comprises displacing adjacent metal portions of the break-away head.

27. The method according to claim 25, wherein forming the at least one tool stop comprises forming a plurality of radially inwardly extending tool stops.

28. The method according to claim 25, wherein forming the body further comprises forming the tool-receiving passageway of the body to extend only partway therein.

29. The method according to claim 25, wherein forming the break-away head comprises forming said break-away head with a reduced diameter portion adjacent the body.

30. The method according to claim 25, wherein the tool-receiving passageway of the body and the tool-receiving passageway of the break-away head each have a hexagonal cross-sectional shape.
